(19) United States
(12) Patent Application Publication
(10) Pub. No.: US 2019/0052459 A1
(43) Pub. Date: Feb. 14, 2019

(54) METHOD FOR GENERATING A SECRET IN A NETWORK HAVING AT LEAST TWO TRANSMISSION CHANNELS

(71) Applicant: Robert Bosch GmbH, Stuttgart (DE)

(72) Inventors: Timo Lothspeich, Weissach (DE); Thomas Keller, Rottweil (DE); Thorsten Schwepp, Korb (DE)

(21) Appl. No.: 15/763,483

(22) PCT Filed: Oct. 10, 2016
(86) PCT No.: PCT/EP2016/074208

§ 371 Date: Mar. 27, 2018

(30) Foreign Application Priority Data
Oct. 15, 2015 (DE) 10 2015 220 008.6

(51) Int. Cl. H04L 9/08; H04L 29/06

(52) U.S. Cl. CPC H04L 9/0838; H04L 2209/84; H04L 63/18

(57) ABSTRACT

A method for generating a secret in a network that has two or more users, which are connected in a data-transmitting manner via at least two transmission channel. For a network communication that is not used for a secret generation, the two users communicate via a first of the at least two transmission channels, and for at least a secret-relevant portion of a network communication that is used for of a secret generation, they communicate via another, second one of the at least two transmission channels.

### FIELD

The present invention relates to a method for generating a secret in a network having two or more users, and to a user of such a network.

### BACKGROUND INFORMATION

In German Patent Application No. DE 10 2015 207 220 A1, a method is described for generating a secret or key in a network, which utilizes a superposition of signals from two users on a common transmission medium. The network has at least one first and one second user as well as a transmission channel between at least the first and the second user. The first and the second user may each output at least one first value and one second value onto the transmission channel. The first user and the second user initiate a respective first user-value sequence and a second user-value sequence for the mutually largely synchronous transmission onto the transmission channel. On the basis of information pertaining to the first user-value sequence and the second user-value sequence, and on the basis of a superposition-value sequence that results on the transmission channel from a superposition of the first user-value sequence with the second user-value sequence, the first user and the second user generate a shared secret or a shared cryptographic key.

Such a method is especially suitable for communications systems which provide for a transmission of dominant and recessive bits or, correspondingly, of dominant and recessive signals, a dominant signal or bit of a user of the network taking precedence over recessive signals or bits. One pertinent example is a CAN (Controller Area Network), in which access to this bus is carried out with the aid of a bit-by-bit bus arbitration, which operates according to this transmission method with dominant and recessive bits. Further examples are TTCAN, CAN FD, LIN as well as I²C. These transmission methods have a long track record and are easily implementable using time-tested and standardized network interface components such as what is known as a network controller, for instance. A transceiver component (also known as a bus driver or medium attachment unit (MAU)) is responsible for the direct physical bus coupling. For a conventional network connection of a processing unit (e.g., a microcontroller), a network interface component, which may also be an integrated component of the processing unit, is therefore used for generating the logical signals, and a transceiver component, which is connected thereto in a data-transmitting manner, is used for the generation of the physical signals.

However, the use of such a method causes difficulties in networks that do not allow for a transmission of dominant and recessive bits and in networks in which individual network segments are connected via so-called gateways. In this case, users from different network segments are unable to establish a shared secret without knowledge of the associated gateway.

### SUMMARY

According to the present invention, a method for generating a secret in a network having two or more users is provided, and also a user of such a network. Advantageous developments are described herein.

In accordance with the present invention, the two network users communicate by way of a first of at least two transmission channels for a network communication that is not used for the secret generation, and that they communicate by way of another, second one of the at least two transmission channels for at least a secret-relevant portion of a network communication that is used for the secret generation. This avoids that messages for generating a secret (i.e., the establishment of a shared secret) have to compete with messages of a normal communication. Moreover, it is possible to establish a shared cryptographic secret for networks that initially do not meet the required physical characteristics (dominant/recessive bits). Depending on the selected architecture, the present invention additionally has advantages with regard to the achievable performance and security during the internal processing. Moreover, the introduced approach allows for the generation of secrets in network topologies in which the first transmission channel between the two involved communication partners runs via one or more gateway(s), in that a direct data link of the network users is established for the secret generation through the second transmission channel.

The present invention makes it possible to establish a shared secret between two different users of a network, which may be used especially for generating a symmetrical cryptographic key. Generally, however, such a shared secret may also be used for purposes other than cryptograph keys within the stricter sense, e.g., as a one-time pad.

As explained, the present invention uses the establishment of an additional, second transmission channel for at least the secret-relevant portion of the network communication that is used for the secret generation. This second transmission channel may therefore be used for establishing a shared secret, from which a cryptographic key, in particular, may then be derived, which in turn is able to be used on the first transmission channel for the cryptographic securing of messages. The second transmission channel may be realized on the same transmission medium as the first transmission channel, e.g., with the aid of known broadband methods using multiple carrier frequencies, and/or multiplex methods, or it may be realized on different transmission media. A transmission channel refers to a logical data link between the two users.

In the event that the network communication used for the secret generation also includes a non-secret-relevant portion (e.g., the communication of control data such as transmitter and/or receiver information, synchronization information, clock information, etc.) in addition to the secret-relevant portion (in particular a communication of random numbers), then it may be provided according to one further refinement of the present invention that either both the secret-relevant portion and the non-secret-relevant portion of the network communication used for the secret generation are conducted by way of the second transmission channel, or that the secret-relevant portion is conducted by way of the second transmission channel and the non-secret-relevant portion is conducted by way of the first transmission channel.

For practical purposes, the second of the at least two transmission channels is designed for the transmission of dominant and recessive signals; in other words, in a simultaneous output of a signal by both users, the dominant state always comes about in the superposition as long as at least one of the two signals is dominant, and the recessive state will only come about if both signals are recessive.

A method for generating a secret is preferably used that is based on a superposition of dominant and recessive signals, e.g., according to the German Patent Application No. DE 10 2015 207 220 A1, and the network has at least one first and one second user as well as a transmission channel between at least the first and the second user. The first and the second user may output at least one first value and one second value onto the transmission channel in each case. The first user and the second user initiate a first user-value sequence and a second user-value sequence for the mutually largely synchronous transmission onto the transmission channel. On the basis of information pertaining to the first user-value sequence and the second user-value sequence, and on the basis of a superposition-value sequence that results from a superposition of the first user-value sequence with the second user-value sequence on the transmission channel, the first user and the second user generate a shared secret.

Generally, however, the present invention may be used for all methods for a secret generation of two communicating users.

In an advantageous manner, the second one of the at least two transmission channels is a point-to-point link between the two users, e.g., Ethernet or a linear bus such as CAN. The bus may be combined in one or a plurality of passive star point(s).

The second of the at least two transmission channels is advantageously realized in a CAN, TTCAN, or a CAN-FD bus system. In this case, a recessive signal level is displaced by a dominant signal level. The superpositioning of values or signals of the users therefore follows fixed rules, which the users may exploit for deriving information from the superposed value or signal and the value or signal transmitted thereby. Other communication systems such as LIN and I2C are also well suited for the second of the at least two transmission channels. The realization of the first of the at least two transmission channels is freely selectable. Naturally, it is understood that it, too, may be realized in a CAN, TTCAN, CAN-FD, LIN or I²C bus system.

As an alternative, however, the second (just as the first) of the at least two transmission channels may also be realized in a network that features amplitude shift-keying, e.g., on-off keying. Here, too, the superposition is specified in that “transmission” and “no transmission” are available to the users for the selection as signals, and the superposition signal corresponds to the signal “transmission” if one or both user(s) is/are transmitting, and it corresponds to the signal “no transmission” if both users are not transmitting.

In packet-switched methods, such as CAN or Ethernet, the network communication used for the secret generation is carried out with the aid of messages or frames that include both useful data (in what is known as the payload or data) and metadata (in what is known as the header and trailer or footer). The metadata may include a message length, transmitter/receiver information, a check sum, etc., for instance.

It may preferably be provided that at least the secret-relevant portion of the network communication used for the secret generation is carried out in a packet-switched manner via the second transmission channel. It is then useful to transmit the secret-relevant portion (and optionally also the non-secret-relevant portion) of the data used for the secret generation in the payload, and to generate the header and footer, if provided, in such a way that a message is created that is detected as a protocol-conformant message by uninvolved users. In particular, existing check sums are then specified in such a way that they correspond to the states in the payload created by the superposition.

As an alternative, it is also preferred to carry out at least the secret-relevant portion of the network communication used for the secret generation in a line-conducted manner by way of the second transmission channel. For the duration of a connection, the transmission channel is exclusively available for the exchange of information between the two participating users. In the process, data are transmitted on a continuous basis, in particular. If no data are due to be transmitted, then fill bits are able to be transmitted instead of information. In this case, too, the portion of the network communication that is not used for the secret generation may be carried out by way of the first transmission channel, as previously mentioned.

A user according to the present invention, e.g., a control unit, a sensor or an actuator, in particular of a motor vehicle, an industrial plant, a home-automation network, etc., is designed, especially in terms of programming technology, for executing a method according to the present invention, and for this purpose it particularly includes at least two logical interfaces for at least two transmission channels. The particular logical interface of the at least two logical interfaces that is allocated to the second transmission channel expediently uses a bus driver component which is designed to process dominant and recessive signals.

Additional advantages and further refinements of the present invention result from the description and the figures.

The present invention is schematically shown in the figures with the aid of exemplary embodiments and described below with reference to the figures.

### BRIEF DESCRIPTION OF THE DRAWINGS

FIG. 1 schematically shows two preferred specific embodiments of a network as it may form the basis of the present invention.

FIG. 2 schematically shows a second preferred specific embodiment of a network as it may form the basis of the present invention.

FIG. 3 schematically shows a third preferred specific embodiment of a network as it may form the basis of the present invention.

FIG. 4 schematically shows a preferred specific embodiment of a user according to the present invention.

### DETAILED DESCRIPTION OF EXAMPLE EMBODIMENTS

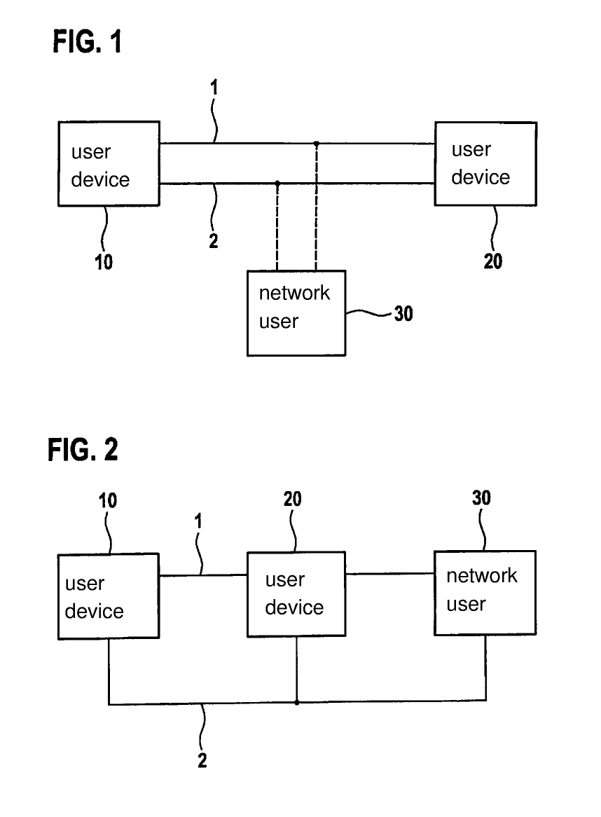

FIGS. 1 through 3 schematically show preferred specific embodiments of a network as it may form the basis of the present invention. Identical elements are denoted by the same reference numerals.

FIG. 1 schematically shows two preferred specific embodiments of such a network. The first specific embodiment includes two users 10, 20, which are connected in a data-transmitting manner via a first transmission channel 1 and a second transmission channel 2. In this first specific embodiment, both the first and the second transmission channel are implemented in the form of a point-to-point connection, such as an Ethernet.

The second specific embodiment additionally includes network user 30, which is linked via the connections shown as dashed lines, so that, overall, both the first transmission channel 1 and the second transmission channel 2 are developed as a linear bus, e.g., a CAN bus, in each case.

In these examples, any two users may generate a secret in a pairwise manner utilizing second transmission channel 2, even if, for instance, first transmission channel 1 does not support the physical conditions required for the secret generation, such as the transmission of dominant and recessive signals.

FIG. 2 shows a network in which the three users 10, 20, 30 are connected in a point-to-point connection by way of first transmission channel 1, middle user 20 functioning as a gateway, and are connected in a linear bus via second transmission channel 2. In this specific embodiment, two users in each case are able to generate a secret as a pair, using second transmission channel 2, despite the lack of a direct connection via first transmission channel 1 between users 10 and 30.

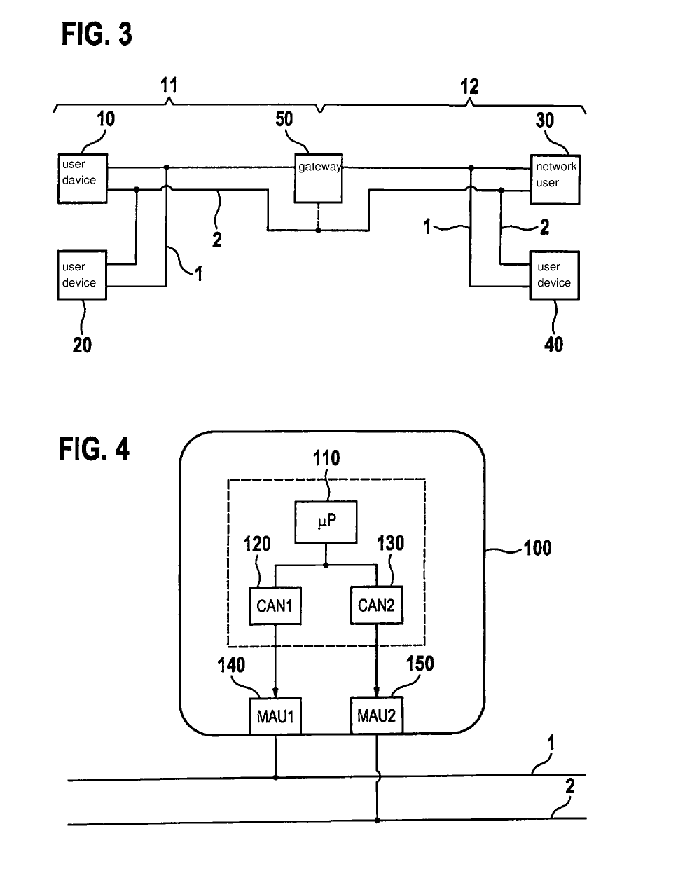

FIG. 3 shows a network in which two network segments 11 and 12 are connected in a data-transmitting manner with the aid of a gateway 50. In such a situation, it is initially not possible for two users from different network segments to generate a shared secret without knowledge of gateway 50 via first transmission channel 1. According to one preferred specific embodiment of the present invention, this problem is now able to be solved in that second transmission channel 2 is provided, which enables a direct network connection between users of the one network segment to users of the other network segment, in this instance, as a linear bus. If gateway 50 is a user as well, then it may also be connected to second transmission channel 2, which is sketched by the dashed line.

For practical purposes, second transmission channel 2 is set up for the transmission of dominant and recessive signals in each case; in other words, during a simultaneous transmission of a respective signal by both users, the dominant state always comes about in the superposition as long as at least one of the two signals is dominant, and the recessive state results only when both signals are recessive. For the secret generation, it is then possible to use the advantageous method described in DE 10 2015 207 220 A1 that was referenced above. However, the illustrated networks are suitable for all secret-generating methods of two communicating users. First transmission channel 1 may be a development of any type of communications system, without any specific requirements. It is understood that it may also basically correspond to the same specifications as second transmission channel 2.

FIG. 4 shows a preferred specific embodiment of a user 100 according to the present invention, e.g., a control unit, a sensor or an actuator, in particular in a motor vehicle, in a schematized form and as a circuit diagram.

User 100 is physically connected to a first network, for instance a CAN bus, by way of a first bus-driver component (a transceiver or a medium attachment unit (MAUI) 140. First transmission channel 1 is realized in the first network. At the same time, user 100 is physically connected to a second network, e.g., also a CAN bus, via a second bus-driver component (MAU2) 150. Second transmission channel 2 is realized in the second network.

User 100 has two logical interfaces for the two transmission channels, i.e., one for the first and one for the second transmission channel. The logical interfaces may be physically developed in different ways, FIG. 4 illustrating one exemplary realization.

The user has a central processing unit, e.g., a microprocessor (μP) 110, as well as a first network-interface component (communications controller), which is developed as a CAN controller (CAN1) 120 in this particular realization. It also includes a second network-interface component, which is also implemented as a CAN controller (CAN2) 130. Elements 110, 120, and 130 may also be part of a microcontroller, which is sketched by a dashed line in FIG. 4.

For a conventional transmission process, the central processing unit writes the payload data (in particular the identifier, the specification as to whether this frame is a data frame or a remote-transmission request frame, the number of data bytes that are to be transmitted, and the data bytes to be transmitted) into the transmit data buffer of CAN controller 120, which then prepares them for the transmission on the bus and transmits the entire frame to transceiver component 140, which is responsible for the direct bus coupling. In other words, CAN controller 120 relieves the central processing unit of all data-transmission operations because it takes care of the composition of the message, the calculation of the CRC sum, the access to the bus (the bus arbitration), the transmission of the frames and the error check, on its own.

In contrast, second transmission channel 2 is used for the network communication that is used for the secret generation. The technical process is able to be carried out in the way as just described in connection with the conventional transmission process. At least one secret-relevant portion (in particular the communication of random numbers) is carried out via second communications channel 2. A portion that is not secret-relevant (e.g., the communication of control data such as transmitter and/or receiver information, synchronization information, clock information, etc.) is able to be carried out via the first and/or via the second transmission channel.

In systems in which greater security demands prevail, a so-called security module (SM) is frequently integrated into the microcontroller in the form of hardware (HSM) or software (SSM). A HSM usually also includes a processor and has access to dedicated microcontroller connections (pins). Therefore, one particularly advantageous architecture according to another realization is the integration of the functions of the second network-interface component in the form of hardware and/or software technology into a security module.

In addition, according to yet another realization, the functions of the first and/or the second network-interface component may also be realized with the aid of what is known as bit banging, i.e., may be realized as software and by the use of an I/O component having a specific number of I/O pins. Bit banging is a technology that emulates a hardware interface with the aid of software and I/O (input/output) pins, which is usually realized by a specific periphery component (and thus by the network-interface component in this particular case). Both the serial and the parallel interface may be utilized on a PC. In microcontrollers, the I/O pins are employed, such as fixedly defined I/O or GPIO (general purpose input/output), i.e. connections or pins that are randomly configurable as input or output. In other words, it is not the network-interface component but rather I/O pins that output(s) the logical signals to be transmitted to the bus-driver component for the generation of the physical signals, and the received signals are not forwarded to the network-interface component but likewise to the I/O pins.

1-10. (canceled)

11. A method for generating a secret in a network having two or more users, which are connected in a data-transmitting manner via at least two transmission channels, the method comprising:
communicating, between the two users by way of a first one of the at least two transmission channels, a network communication that is not used for a secret generation; and
communicating, between the two users by way of another, second one of the at least two transmission channels, at least a secret-relevant portion of a network communication that is used for a secret generation.

12. The method as recited in claim 11, wherein the at least two transmission channels are realized on the same or on different transmission media.

13. The method as recited in claim 11, wherein the second of the at least two transmission channels is designed to transmit dominant and recessive signals.

14. The method as recited in claim 11, wherein a non-secret-relevant portion of the network communication used for the secret generation is carried out via one of the first or the second of the at least two transmission channels.

15. The method as recited in claim 11, wherein the second of the at least two transmission channels is a point-to-point connection between the two users or a linear bus.

16. The method as recited in claim 11, wherein at least the secret-relevant portion of the network communication that is used for the secret generation is carried out via the second of the at least two transmission channels in a packet-conducted or a line-conducted manner.

17. A user device, configured to generate a secret in a network having two or more users, which are connected in a data-transmitting manner via at least two transmission channels, the user configured to:
communicate, with a second user device by way of a first one of the at least two transmission channels, a network communication that is not used for a secret generation; and
communicate, with the second user device by of another, second of the at least two transmission channels, at least a secret-relevant portion of a network communication that is used for a secret generation.

18. The user device as recited in claim 17, wherein the user device includes at least two logical interfaces for the at least two transmission channels.

19. The user device as recited in claim 18, wherein a particular interface of the at least two logical interfaces that is allocated to the second of the at least two transmission channels is implemented using a bus-driver component, which is designed to process dominant and recessive signals.

20. The user device as recited in claim 17, wherein the user device is implemented as one of a control unit, a sensor or an actuator, a motor vehicle, an industrial plant, or a home-automation network.
